(19) United States
(12) Patent Application Publication
(10) Pub. No.: US 2002/0015405 A1
(43) Pub. Date: Feb. 7, 2002

(54) Error correction of important fields in data packet communications in a digital mobile radio network

(76) Inventors: Risto Sepponen, Espoo (FI); Ger-Jan van Lieshout, Apeldoorn (NL); Bo Karlander, Sollentuna (SE); Franz Heiser, Numberg (DE)

Correspondence Address: NIXON & VANDERHYE P.C., 8th Floor, 1100 North Glebe Road, Arlington, VA, 22201, US

(21) Appl. No.: 09/867,714

(22) Filed: May 31, 2001

Related U.S. Application Data
(60) Provisional application No. 60/214,004, filed on Jun. 26, 2000.

(51) Int. Cl. H04L 12/28; H04L 12/56

(52) U.S. Cl. 370/389; 370/474; 370/328

(57) ABSTRACT

A data packet format includes an important information field in a data packet header or payload, e.g., a transport format indication field including one or more indicating the transport format for the data packet. It also includes one or more error correction bits associated with the important information field, (e.g., the transport format indication field), usable by an error correction scheme at a receiver to correct errors in the received header. An error detection field in the data packet is used at the receiver to detect such bit errors. In one example implementation, the one or more error correction bits are positioned in spare or unused bit locations in the data packet. In a further implementation, one or more unused bits in the important data field are used to carry the one or more error correction bits. A particular example is the use of one or more most significant bit positions of the important data field to carry error correction bits while remaining less significant bit positions carry important data information. Alternatively, spare or unused bit locations in multiple data packets may be used to carry error correction bits. Still further, in a transport format indication field example, the error correction information may be determined by the receiver based on a set of available transport format combinations.

This application claims priority from commonly-assigned U.S. Provisional Patent Application Serial No. 60/214,004, entitled “Error Correction of Important Data Fields,” filed on Jun. 26, 2000, the disclosure of which is incorporated herein by reference.

### FIELD OF THE INVENTION

The present invention relates to digital communications, and more particularly, to error correction of important data fields in data packet communications. The present invention finds advantageous application to packet data communications in a mobile radio communications network.

### BACKGROUND AND SUMMARY OF THE INVENTION

For digital data transfer, digital information is divided into packets of a certain size prior to transfer over the communications channel. Each data packet comprises a certain number of bits. One group of the bits forms a payload of a packet, and another group of bits forms a header of the packet, typically containing certain control information. Nodes that transfer data packets in the communications system use the header of each packet to route that packet towards its correct destination or to send the data packet in a correct format or at a correct time. Example protocols used to control packets during transfer in the Internet include Transmission Control Protocol (TCP), User Datagram Protocol (UDP), and Internet Protocol (IP). These protocols establish how digital data are assembled into different packets, and how each packet is routed from one node to another on the way to its destination.

In wireless data transfer supported in Universal Mobile Telephone Systems (UMTS) and General Packet Radio Systems (GPRS), similar data packet routing protocols are also employed. In contrast to wireline communications, wireless communications suffer from error rates that are much larger than in fixed networks. Motion of the mobile radios increases the likelihood of such errors due to changes in radio coverage and doppler effects. Doppler effects cause changes in radio frequency and phase that increase the likelihood of data corruption.

Because the information header must be correctly received in order for the payload information to be routed to and decoded at its proper destination, the ability to detect, and if possible, correct errors in the packet header is important. It may also be valuable to detect, and if possible, correct errors for important fields in the packet payload. Error detection and/or correction are typically accomplished by adding redundant bit information to the transmitted data, which is used by the receiver to detect and possibly correct detected errors. The problem with adding redundancy is reduced throughput. One way to offset this reduced throughput from the increased “overhead” caused by the added redundancy would be to increase the payload size, and therefore, the size of the overall data packet. However, increasing the packet size leads to longer delays in data transfer and also increases the chance of bit errors affecting the payload. In any event, detected errors which are not corrected require retransmission of that same information which increases delay, and therefore, reduces throughput. Indeed, the packet roundtrip delay is considerable because packets are typically interleaved in radio communications. Specifically, channel encoding may spread the data bits of a single data packet between two or more blocks of packets so that gathering the complete data for an entire packet may require reception of two or more blocks which are combined to produce the original packets in their correct order.

In some radio communication systems that employ data packet communications, such as third generation cellular radio systems, control and data frames or blocks, each having a protocol header and a payload, include in the header transport format indication (TFI) information. The term data block or data packet as used herein refer to any physical or logical block of data. In such systems, the TFI conveys information regarding the structure of the data blocks (transport blocks) in the payload sometimes called the transport format. To read and interpret the payload data, it is important to accurately receive and decode the header, and especially, the TFI. For a corrupted header, there is no guarantee that the payload can be accurately interpreted. Error detection information, such as cyclic redundancy code (CRC) check sum bits, are included in the header to detect header corruption by error. If there is a detected error in the header, the entire frame is ignored. The corrupted frame must therefore be resent causing delay and extra loading on the transport channels.

An object of the present invention is to provide a mechanism for making important data fields in a data packet more robust. For example, a more robust header results in faster and more reliable data transmission. One example of important header information is transport format indication information.

Another object of the present invention is to provide an error correction mechanism in addition to an error detection mechanism in the header or the payload to achieve greater header robustness.

A further object of the present invention is to preferably provide such error correction without adding to the length of the header or payload.

A data packet format includes an important information field, e.g., a transport format indication header field including one or more bits indicating the transport format for the data packet. The important information field also includes one or more error correction bits associated with the important information field, (e.g., the transport format indication field), usable by an error correction scheme at a receiver to correct errors in the received data packet. An error detection field in the data packet is used at the receiver to detect such bit errors. In one example implementation, the one or more error correction bits are positioned in spare or unused bit locations in the data packet. In a further implementation, one or more unused bits in the important data field, (e.g., a transport format indication field), are used to carry the one or more error correction bits. A particular example is the use of one or more most significant bit positions of the important data field, (e.g., transport format indication field), to carry error correction bits while remaining, less significant bit positions carry the important data field information, (e.g., transport format indication information). Alternatively, spare or unused bit locations in multiple data packet fields may be used to carry error correction bits. Still further, in the transport format indication field example, the error correction information may be determined by the receiver based on a set of available transport format combinations.

The present invention may be implemented in a transmitter in order to prepare a data packet having a header and a payload for transmission over a Radio Access Network interface for use in a radio communications network. In addition, the present invention can be implemented in a radio receiver which receives a data packet having an important data field, processes the important information and one or more error correction bits associated with one or more important information bits, and uses those one or more correction bits in an error correction scheme.

### BRIEF DESCRIPTION OF THE DRAWINGS

The foregoing and other objects, features, and advantages of the invention will be apparent from the following description of preferred, non-limiting example embodiments, as well as illustrated in the accompanying drawings. The drawings are not to scale, emphasis instead being placed upon illustrating the principles of the invention.

FIG. 1 illustrates an example data packet and header in accordance with the present invention;

FIGS. 2A and 2B illustrate an example of the transmission and reception of transport blocks with transport format indication information;

FIGS. 3A and 3B illustrate example procedures for implementing the present invention in a transmitter and in a receiver, respectively,

FIG. 4A illustrates an example radio communications network in which the present invention may be advantageously employed;

FIG. 4B illustrates an example radio unit, e.g., in a base station or in a user equipment, for implementing the present invention;

FIGS. 5 and 6 illustrate data communication protocols used in the radio communications network show in FIG. 4A;

FIG. 7 illustrates an example data packet for transmission over a dedicated channel in the radio communications network shown in FIG. 4A; and

FIGS. 8 and 9 show two examples of error correction bits associated with the header of the data frame (an example data frame is shown in FIG. 7).

### DETAILED DESCRIPTION

In the following description, for purposes of explanation and not limitation, details are set forth pertaining to a specific UTRAN architecture, having certain interfaces, signaling, and messages, in order to provide an understanding of the present invention. However, it will be apparent to one skilled in the art that the present invention may be practiced in other implementations, embodiments, and contexts that depart from these specific details.

In some instances, detailed descriptions of well-known methods, interfaces, devices, and signaling techniques are omitted so as not to obscure the description of the present invention with unnecessary detail. Moreover, individual function blocks are shown in some of the figures. Those skilled in the art will appreciate that the functions may be implemented using individual hardware circuits, using software functioning in conjunction with a suitably programmed digital microprocessor or general purpose computer, using an application specific integrated circuit (ASIC), and/or using one or more digital signal processors (DSPs).

Although the present invention may be applied to any important data field or information in the header and/or payload of a data packet or data block, the following examples and embodiments are described in the context of an important data field in the header. Specifically, that example header field carries transport format indication information. However, these examples and embodiments are for purposes of illustration only. They do not limit the invention to TFI header fields or to header fields in general.

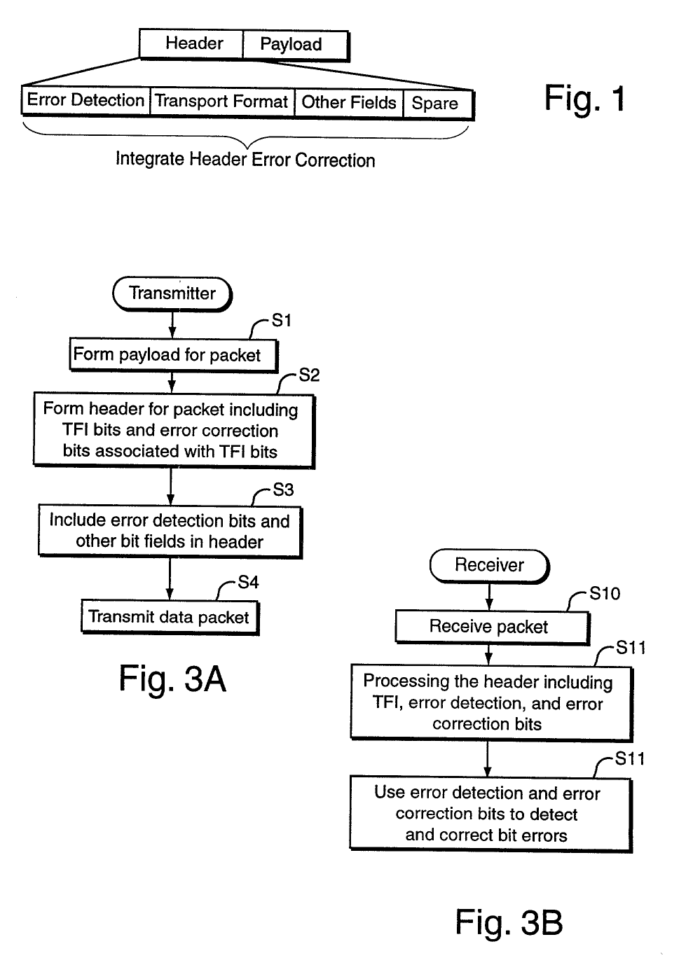

A data packet (or any other type of data unit such as a data frame, data block, etc.) is shown in FIG. 1 includes a header portion and a payload portion. The header includes an error detection field, a transport format field, as well as other fields. Such headers often also include spare or unused bits often incorporated in protocols in the event there is future functionality to be added to the header. Because of the importance of the header information, and in particular transport format indication information, the present invention incorporates error correction for the transport format indication information in the header. Error correction bits may be added to unused or spare bit locations in one or more fields of the header. Alternatively, the header error correction may be derived from information inherent in or deducible from one or more fields in the header. For example, only certain transport formats are available which means that the information in the transport format field must be one of the available transport formats. If the received information does not match one of those formats exactly, it may be corrected to the format it most closely resembles.

In radio communications systems, data generated at higher protocol layers is carried over the radio/air interface with transport channels that are matched at the lowest protocol layer—the physical layer—to different physical channels. Indeed, in third generation mobile radio systems, the physical layer is required to support a number of features such as variable bit rate transport channels to offer bandwidth-on-demand services and to be able to multiplex several services to one mobile subscriber logical connection. Thus, mapping of the transport channels to the physical channels taking into account such requirements is an important function and is typically orchestrated using some sort of transport format indicator (TFI) associated with or otherwise accompanying each transport channel.

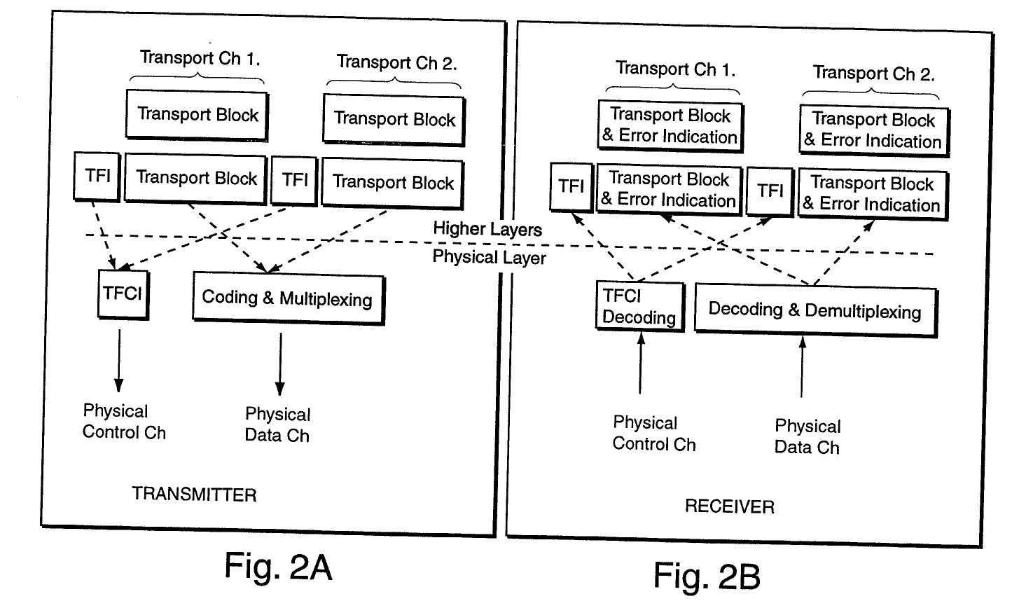

FIGS. 2A and 2B illustrate one example of how such transport format information is indicated and how transport channels may be mapped to physical channels. For example, FIG. 2A shows a transmitter in which two transport channels 1 and 2 provide a transport block from higher protocol layers to the physical layer. Each transport channel's transport block includes an associated transport format indicator (TFI). The physical layer in the transmitter combines the TFI information from the two different transport channels into a single transport format combination indicator (TFCI) which is then transmitted on a physical control channel. The transport blocks from the two transport channels are mapped to a single physical data channel in a coding and multiplexing function block. The transport channels may have a different number of transport blocks, and at any moment, not all the transport channels are necessarily active.

At the receiver, the TFCI information from the physical control channel is decoded into corresponding transport channel TFI information that is then associated with each transport block decoded and demultiplexed from the physical data channel to enable proper interpretation of the data frame when the transport channel information is received in the next Radio Access Network node. The format of each transport block in the payload is defined by a corresponding transport format indicator, which contains the transport block size, the transport block set size, and potentially other specifications such as transport block data rate. To be able to read and interpret the payload data, therefore, it is essential that header information, and especially the TFI information, is accurately transmitted and received. If the header is corrupted, there is no guarantee that the payload can be accurately interpreted. As a result, an entire data frame, typically made up of multiple data packets, ultimately may be ignored if the error detection bits processed by the receiver reveal corruption in the header. Accordingly, a corrupted frame would have to resent causing delay and extra loading on the transport channels, or will result in a service quality degradation. Header robustness, which is important for fast and reliable data transmission, is ensured in the present invention by integrating header error correction, and in particular, error correction with respect to the transport format bits.

An example of integrated header error correction is now described in conjunction with the flowchart diagrams illustrated in FIGS. 3A and 3B. An example transmitter procedure is illustrated in FIG. 3A. Initially, the payload for a data packet is formed including one or more transport blocks (step S1). A header for the data packet is associated with the payload and includes transport format indication bits as well as error correction bits associated with the TFI bits (step S2). Error detection bits and other bits may be included in the header (step S3). The thus-formed data packet is then transmitted over the radio interface using physical radio channel resources (step S4).

An example procedure executed by a receiver includes receiving the transmitted data packet from the radio interface (step S10). The receiver processes the header of the received packet including the TFI, error detection, and error correction bits (step S11). The receiver uses error detection and error correction bits included in the header to detect and correct bit errors in the header, and in particular, errors in the TFI (step S12). One or more known error detection (such as CRC check) algorithms and error correction algorithms may be employed to detect and correct errors in the header information.

While the invention maybe employed in any communications system, including both wireline and wireless, the present invention finds advantageous example application to third generation mobile radio telecommunications systems. Wideband Code Division Multiple Access (WCDMA) technology has emerged as the most widely-adopted third generation air interface. Its specification has been created has been created in the Third Generation Partnership Project (3GPP) which is a joint standardization project of standardization bodies from Europe, Japan, Korea, the USA, and China. Within 3GPP, WCDMA is called Universal Terrestrial Radio Access (UTRA), and the name WCDMA is used to cover both frequency division duplex and time division duplex operations.

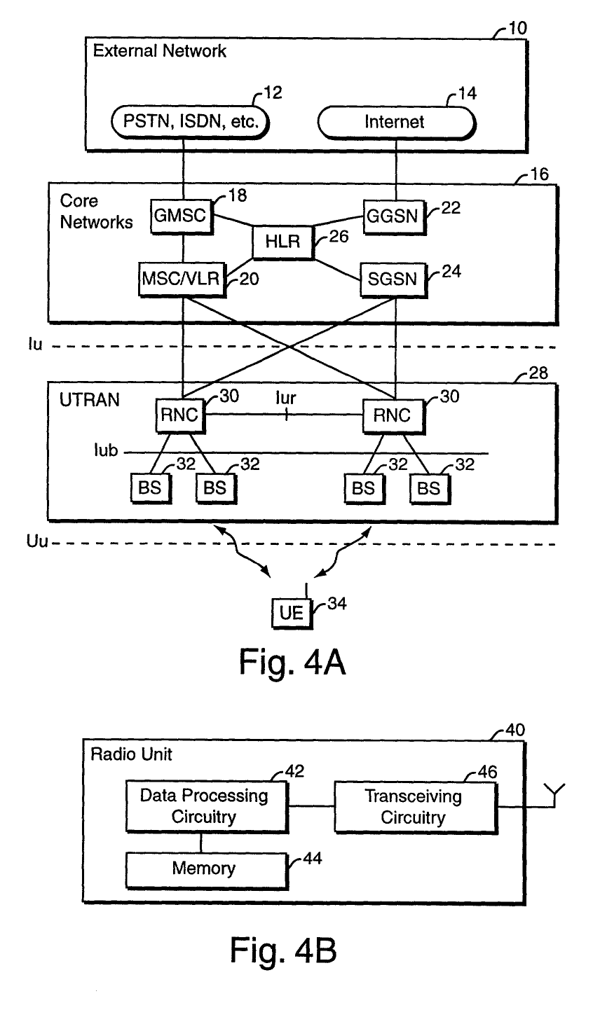

FIG. 4A illustrates a system-wide architecture of a Universal Mobile Teleconmmunications System (UMTS) including logical network elements and interfaces. In particular, the network elements of the UMTS architecture includes external networks 10 divided into two groups: circuit-switched networks 12, such as the PSTN and ISDN, and packet-switched networks 14, such as the Internet. The external networks 10 are connected to corresponding core networks 16. Specifically, circuit-switched connections from the circuit-switched core networks 12 are handled by a Gateway Mobile Switching Center (GMSC) 18 well known from GSM cellular systems. Packet-switched data from the Internet 14 is coupled to a Gateway General Packet Radio Service (GPRS) Support Node (GGSN) 22 which is analogous in terms of its functionality to the GMSC 18 but in relation to packet-switched services. The GMSC 18 is coupled to a Mobile Switching Center (MSC)/Visitor Location Register (VLR) 20 which are the switch and database, respectively, that serve the subscriber using equipment in its current location for circuit-switched services. The MSC switches the circuit-switched transactions, and the VLR stores a copy of the visiting user's service profile as well as more precise information on the user equipment's location within the serving system. The Serving GPRS Support Node (SGSN) 24 has functions similar to that of the MSC/VLR 20, but is typically used for packet-switched services. The Home Location Register (HLR) 26 is a database located in the user equipment's home system that stores a master copy of the user's service profile. The service profile includes for example information on allowed services, forbidden roaming areas, and supplementary service information such as call forwarding and the call forwarding number. For purposes of routing incoming calls to the user equipment, the HLR 26 also stores the user equipment location on the level of the MSC/VLR and/or SGSN, i.e., on the level of the serving system.

The UMTS Terrestrial Radio Access Network (UTRAN) 28 includes two nodes. Radio network controller (RNC) nodes 30 control radio resources for the base stations 32 coupled to the RNC 30. The RNC 30 is the service access point for all services that the UTRAN 28 provides to the core networks 16, e.g., management of connection to the user equipment (UE) 34. The base stations convert the data flow between the IUB and UU interfaces. They also participate in radio resource management. The user equipment is the mobile terminal used for radio communication over the UU interface.

FIG. 4B shows an example radio unit 40 representative of certain functions performed both in the user equipment 34 and base station 32. The radio unit 40 includes data processing circuitry 42 coupled to memory 44 and transceiving circuitry 46. The memory stores subscriber information as well as executable algorithms and other data. The transceiving circuitry 46 takes care of the necessary radio processing tasks including preparation and transmission of data packets over the radio interface and reception and processing of received data packets.

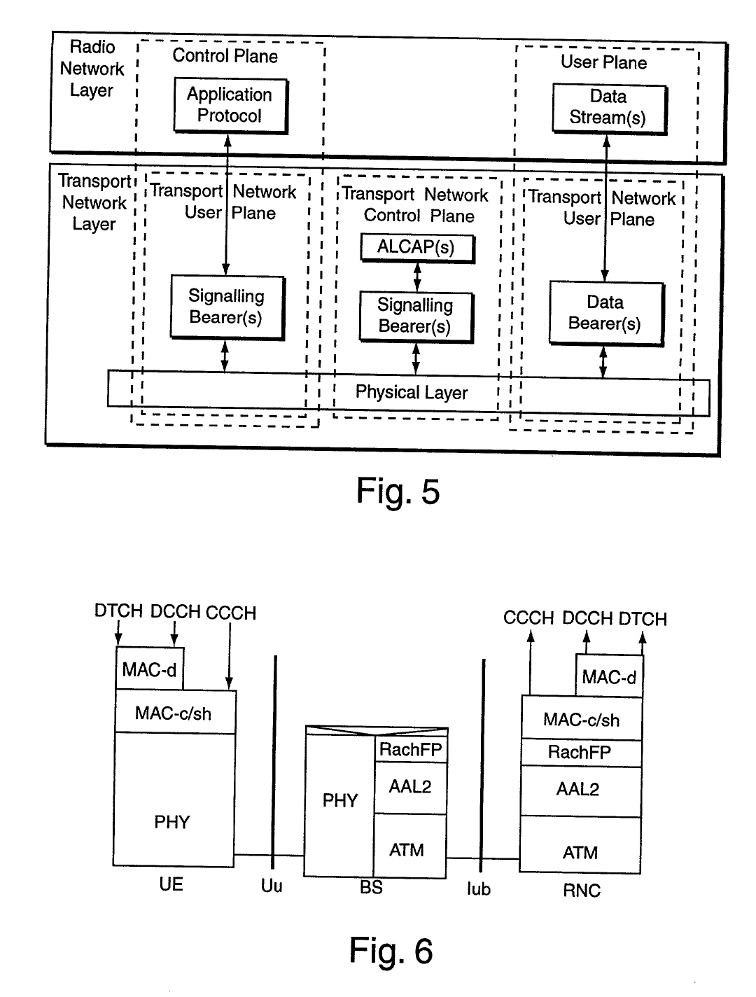

FIG. 5 illustrates protocol structures in the UTRAN. This protocol structure is based on the principal that the layers and planes are logically independent of each other. The protocol structure includes two main layers: the radio network layer and the transport network layer. The control plane is used for all UMTS-specific control signaling, and all information received by the user such as voice and data packets are transported via the user plane. The user plane includes data streams, and the logical data bearers that “bear” the data streams. Each data stream is characterized by one or more frame protocols specified for the interface. The transport network control plane is used for all control signaling within the transport layer and is a plane that acts between the control and user planes. Data bearers in the user plane are controlled by the transport network control plane.

User data is transported in the UTRAN on the transport bearers. These transport bearers may be mapped to AAL2 connections (in the case of an ATM-based transport network) or, to UDP connections (in the case of IP-based transport network). As described in the 3GPP RAN3 specification entitled “Physical channels and Mapping of Transport Channels onto Physical Channels (FDD),” accessible at http://www.3gpp.org/ftp/Specs/December 99/25 series/25302-330. zip, the disclosure of which is incorporated by reference, transport channels form the interface between the physical layer (like ATM/AAL2) and higher layers (Layer 2). The transport channels are classified into two groups: common transport channels and dedicated transport channels. This document also describes the details of the Iub interface.

A common transport channels is used to transport information to/from multiple user equipment units (UEs), whereas a dedicated transport channel is used to transport information to/from one UE. The common transport channels in frequency division duplex (FDD) mode are:

RACH (Random Access channel)

FACH (Forward Access channel)

BCH (Broadcast channel)

PCH (Paging channel)

SCH (Syncronisation channel)

DSCH (Downlink Shared channel)

The DCH dedicated channel) is the only dedicated channel. Each transport channel is mapped to a corresponding physical channel. An example protocol model at the Iub/Iur interface is illustrated in FIG. 6, showing the protocol model of a common RACH channel.

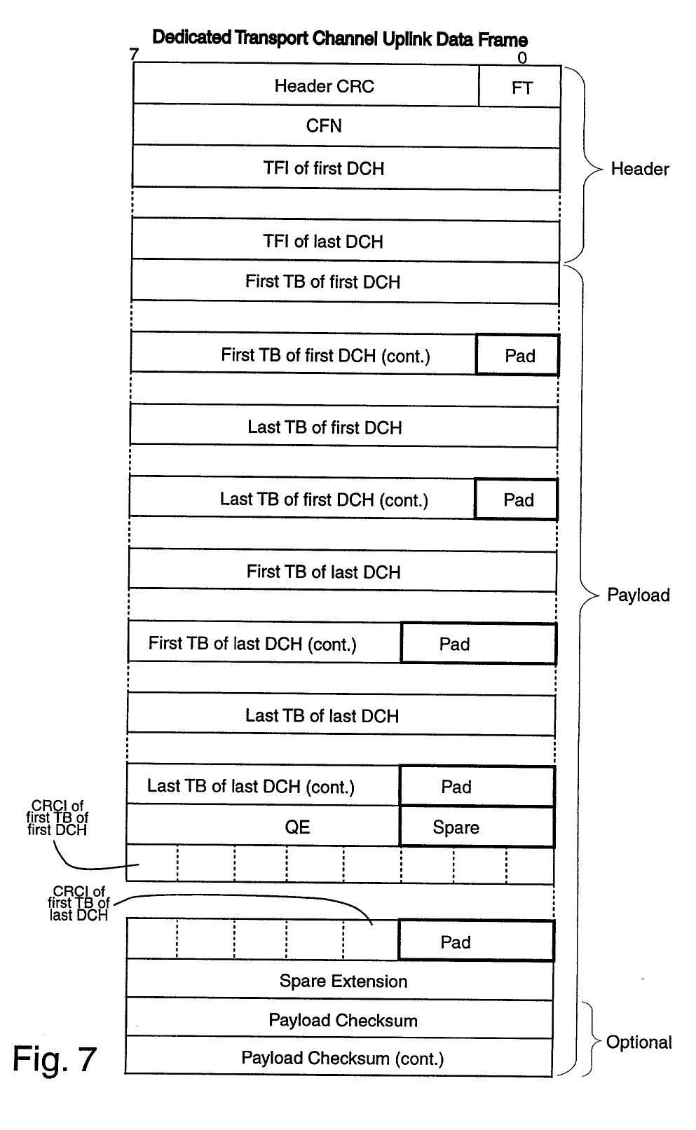

The transport channels have different frame structures. On each transport channel, two types of frames are specified: control frames for transmission of control data and data frames to transport the actual user data. Both control and data frames include a protocol header and payload. An example dedicated transport channel uplink data frame is presented in FIG. 7.

The header includes:

Header CRC, 7 bit checksum applied to the remaining part of the header used for error detection at the receiver

FT, Frame Type, to differentiate data frames and control frames

CFN, Connection Frame Number, indicates the particular radio frame when the frame was received and the particular 10 ms time interval of the data transport at the radio interface

TFI, Transport Format Indicator indicates the structure of the data blocks (transport blocks) in the payload.

The format of the Transport Blocks (data blocks) in the payload is defined by the Transport Format containing the Transport Block size, Transport Block Set size and some other specifications. For each transport channel there is a set of transport formats transport Format Set) available. The Transport Format Indicator (IFI) identifies the Transport format within the allowed set that is applied to the Transport Blocks in the payload.

In the header shown in FIG. 7, the header CRC bits are used by the receiver of the frame to perform error detection, but not error correction of the header. The present invention improves on this error detection handling approach by adding an error correction mechanism to the header. Three non-limiting, example implementations described below.

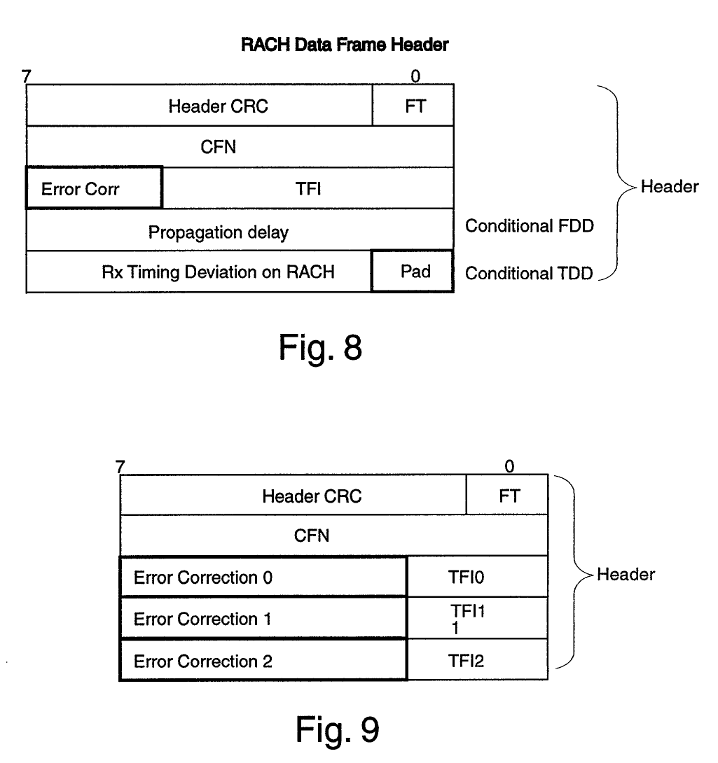

A first example embodiment uses a part or all of a header field that will not be used during the connection to transport substantive information. A non-limiting example of such unused header field is the three most significant bits of the TFI field from a non-limiting, example header shown in FIG. 8 for a RACII data frame header. The four most significant bits of the TFI field are reserved for error correction. Here, the number of TFIs in FIG. 8 is limited to 16, so 4 of the 8 bits in the TFI field can carry the TFI information, i.e., 2⁴⁼16. Because only four of the bits allocated to the TFI field are used, the four most significant bits of the TFI field may be used in accordance with the invention for error correction.

In this first example embodiment (FDD mode), there is information in four header fields: FT, CFN, TFI and Propagation delay. The header contains a total of twenty-two information bits. The four “unused,” most significant error correction bits may be used to provide a limited amount of error correction, e.g., correction of one corrupted bit, by using, e.g., a block code method like Hamming code, which can be useful when error probabilities on an RNC-BS link are fairly low. The four (or even less) error correction bits may also be combined with the seven error detection/CRC bits to achieve at least an 11-bit error detection/correction capability, which enables the correction of two or even three erroneous bits by using, e.g., a cyclic code scheme.

A second example embodiment, similar to the first example, but somewhat more complicated to implement, combines all bits in the header fields that are not in use in the connection and employs them for error correction and/or to increase error detection/error correction capabilities. More specifically, the TFI values are channel-specific, and therefore, the number of TFI values varies from channel-to-channel. In this embodiment, the error correction scheme is dynamic because it uses the maximum number of available (unused) bits for each connection. That maximum number may vary.

In another non-limiting example shown in FIG. 9, there are four different Transport formats in use on a specific channel. Three Transport Format Indicators (TFIs) TFI0, TFI1, and TFI2 use two TFI bits, i.e., 2²=4. In that case, six unused TFI bits are available for error correction for each TFI field. In this example there is information related to three DCH channels combined to one frame. The number of information bits (FT, CFN, TFI0, TFI1, TFI2) is fifteen. The number of error correction bits is eighteen, which enables more advanced error correction algorithms to be applied compared to having just three error correction bits. It is therefore possible to correct more than one corrupted bit. One possible method is a block code or cyclic code scheme as described above.

Both the first and second example embodiments may be used in parallel, so that for some channels a simpler error correction algorithm is used, and for other channels a more advanced error correction algorithm is used to give more powerful error correction capabilities.

A third example embodiment uses the information inherent in or deducible from the contents of the header information for error correction without adding any error correction bits. An example concerns TFI restrictions in the case of multiple dedicated channels (DCHs). For example, for speech connections, three DCH channels are combined (channel A, channel B, and channel C) in one data frame. Each of these channels has a number of Transport Formats with respective Transport Format Indicators (TFIs). In this example, A1 and A2 are the possible TFIs for the channel A, B1 and B2 the possible TFIs for the channel B, and C1 and C2 the possible TFIs for the channel C. The TFI identifies for each channel the allowed Transport Format that applies for that frame.

The allowed Transport Format Combinations TFCs) with respective Transport Format Combination Set Indicators (TFCIs) are predefined. Assume the following combinations are defined to be possible: A1-B1-C1, A2-B2-C1 and A2-B2-C2. In this example, A1 and B1 are presented only in one TFCS in combination with C1. If the TFIs A1 and B1 are received, the receiver knows that the only allowed C value to be combined with A1 and B1 is C1. The possible corrupted TFI of the C channel can be corrected based on the information relating to allowed Transport Format Combination Sets.

The invention reduces a frame drop rate by introducing an error correction capabilities without adding data bits into protocol headers. Accurate frame handling protocol headers are vital for data transport. The three example embodiments described above are only non-limiting examples of the present invention. All three embodiments can be used in parallel or in any combination of two of the three embodiments. Other implementations are envisioned and may be used. The present invention can be applied to any protocol header structure and is not limited to the example, non-limiting DCH uplink data frame structure shown in FIG. 7. Moreover, and as already explained above, the invention is not limited to header structures, but may be applied to any data field containing information whose accuracy is sufficiently important to warrant error correction.

Accordingly, the present invention is not limited to the example embodiments which are set forth in the specification and drawings for purposes of illustration. Therefore, the invention should be limited only by the scope of the claims appended hereto.

What is claimed is:

1. A method for preparing a data packet having a header and a payload for transmission over a radio interface for use in a radio communications network, comprising:
forming the payload for the data packet;
forming the header for the data packet, wherein one of the payload and header contains a data field with one or more bits; and
including in the data packet one or more error correction bits associated with the data field useable by an error correction scheme at a receiver of the data packet to correct an error in the data field.

2. The method in claim 1, wherein the data field is a header data field.

3. The method in claim 1, wherein the data field is a payload data field.

4. The method in claim 1, wherein the data field is associated with one or more error detection bits.

5. The method in claim 1, wherein the one or more error correction bits are positioned in spare or unused bit locations.

6. The method in claim 1, wherein one or m ore unused bits in the data field are used as the one or more error correction bits.

7. The method in claim 6, wherein the one or more data field bits include multiple bits and the one or m ore error correction bits correspond to one or more most significant bits of the data field.

8. The method in claim 1, wherein a number of bits in any one or more data fields is used as the one or more error correction bits.

9. The method in claim 8, wherein the number of bits come from multiple data fields.

10. The method in claim 8, wherein the number of bits corresponds to one or more spare bit locations in the data packet.

11. The method in claim 8, wherein the number of bits may vary.

12. A method for processing a data packet transmitted over a radio interface for use in a radio communications network, comprising:
receiving a radio transmission including a data packet having a header and a payload; and
processing the header including processing one or more bits contained in a data field and one or more error correction bits associated with the data field; and
using the one or more error correction bits in an error correction scheme to correct an error in the data field.

13. The method in claim 12, wherein the data field is a header data field.

14. The method in claim 12, wherein the data field is a payload data field.

15. The method in claim 12, wherein the data field includes one or more error detection bits, the method further comprising:
using the one or more error detection bits to detect an occurrence of an error in thein the data field.

16. The method in claim 15, further comprising:
using the error detection and one or more correction bits to detect and correct errors in the data field.

17. The method in claim 12, further comprising:
using the one or more error correction bits to correct one or more bits in the data field.

18. The method in claim 12, wherein the one or more error correction bits are positioned in spare or unused bit locations in the data packet.

19. The method in claim 12, wherein one or more spare or unused bits are used as the one or more error correction bits.

20. The method in claim 19, wherein the one or more data field bits include multiple bits and the one or more error correction bits correspond to one or more most significant bits of the data field.

21. The method in claim 12, wherein a number of bits in any one or more data fields is used as the error correction bits.

22. The method in claim 19, wherein the number of bits corresponds to one or more spare bit locations in the data packet.

23. The method in claim 19, wherein the number of bits may vary, the method further comprising:
adapting the error correction scheme to the variable number of bits used.

24. The method in claim 12, wherein the data field is a transport format indication data field and a transport channel includes a set of available transport format combinations, further comprising:
determining the one or more error correction bits associated with the transport format indication data field based on the set of available transport format combinations.

25. The method in claim 24, further comprising:
using the set of available transport format combinations to correct one or more errors in the header.

26. A data packet header format for use in a data packet having a header and a payload, comprising:
a transport format indication field including one or more bits indicating a transport format for the data packet, and
one or more error correction bits associated with the transport format indication field usable by an error correction scheme at a receiver of the data packet.

27. The data packet header format in claim 24, further comprising:
an error detection field including one or more error detection bits.

28. The data packet header format in claim 24, wherein the one or more error correction bits are positioned in spare or unused bit locations in the header.

29. The data packet header format in claim 24, wherein one or more unused bits in the transport format indication field are used as the one or more error correction bits.

30. The data packet header format in claim 24, wherein the one or more error correction bits correspond to one or more most significant bits of the transport format indication field.

31. The data packet header format in claim 24, wherein a number of bits in any one or more header fields is used as error correction bits.

32. The data packet header format in claim 24, wherein the number of bits corresponds to one or more spare bit locations in the header.

33. The data packet header format in claim 32, wherein the number of bits may vary.

34. The data packet header format in claim 24, wherein a transport channel includes a set of available transport format combinations, and wherein the error correction bits may be determined by a receiver of the data packet based on the set of available transport format combinations.

35. A data packet format for use in a data packet having a header and a payload, comprising:
a data field including one or more bits, and
one or more error correction bits associated with the data field usable by an error correction scheme at a receiver of the data packet to correct an error in the data field.

36. The data packet format in claim 35, further comprising:
an error detection field including one or more error detection bits.

37. The data packet format in claim 35, wherein the one or more error correction bits are positioned in spare or unused bit locations in the data packet.

38. The data packet format in claim 35, wherein one or more unused bits in the data field are used as the one or more error correction bits.

39. The data packet format in claim 35, wherein the one or more error correction bits correspond to one or more most significant bits of the data field.

40. The data packet format in claim 35, wherein a number of bits in any one or more data fields is used as error correction bits.

41. The data packet format in claim 35, wherein the number of bits corresponds to one or more spare bit locations in the data packet.

42. The data packet format in claim 41, wherein the number of bits may vary.

43. The data packet format in claim 35, wherein the data field is in the header.

44. The data packet format in claim 35, wherein the data field is in the payload.

45. A radio unit for preparing a data packet having a header and a payload for transmission over a radio interface for use in a radio communications network, comprising:
processing circuitry capable of forming the payload for the data packet, the header for the data packet, where one of the payload and header contains a data field including one or more bits, and one or more error correction bits associated with the data field useable by an error correction scheme at a receiver of the data packet to correct an error in the data field, and
a transmitter capable of transmitting the data packet over a radio channel.

46. The radio unit in claim 45, wherein the processing circuitry is capable of forming the data packet with one or more error detection bits.

47. The radio unit in claim 45, wherein the one or more error correction bits are positioned in spare or unused bit locations in the data packet.

48. The radio unit in claim 45, wherein one or more spare or unused bits are used as the one or more error correction bits.

49. The radio unit in claim 45, wherein the one or more error correction bits correspond to one or more most significant bits of the data field.

50. The radio unit in claim 45, wherein a number of bits in any one or more data fields is used as the one or more error correction bits.

51. The radio unit in claim 50, wherein the number of bits corresponds to one or more spare bit locations in the data packet.

52. The radio unit in claim 50, wherein the number of bits come from multiple header fields.

53. The radio unit in claim 50, wherein the number of bits may vary.

54. The radio unit in claim 45, wherein the electronic circuitry and transmitter are located in a stationary radio network node.

55. The radio unit in claim 45, wherein the electronic circuitry and transmitter are located in a mobile radio network node.

56. The radio unit in claim 45, wherein the data field is in the header.

57. The radio unit in claim 56, wherein the header data field is a transport format indication field.

58. The radio unit in claim 45, wherein the data field is in the payload.

59. A radio unit for processing data packets transmitted over a radio interface for use in a radio communications network, comprising:
a receiver configured to receive a radio transmission including a data packet having a header and a payload; and
electronic circuitry configured to process a data field in one of the header and payload of the data packet and one or more error correction bits associated with the data field,
wherein the electronic circuitry is configured to use the one or more error correction bits to correct one or more errors in the received data field.

60. The radio unit in claim 59, wherein the data field includes one or more error detection bits, the electronic circuitry being configured to use the one or more error detection bits to detect an occurrence of an error in the data field.

61. The radio unit in claim 60, wherein the electronic circuitry is configured to use the error detection and one or more error correction bits to detect and correct errors in the data field.

62. The radio unit in claim 59, wherein the electronic circuitry is configured to use the one or more error correction bits to correct one or more bits in the data field.

63. The radio unit in claim 59, wherein the one or more error correction bits are positioned in spare or unused bit locations in the data field.

64. The radio unit in claim 59, wherein the one or more error correction bits correspond to one or more most significant bits of the data field.

65. The radio unit in claim 59, wherein a number of bits in any one or more data fields is used as the error correction field.

66. The radio unit in claim 65, wherein the number of bits corresponds to one or more spare bit locations in the data packet.

67. The radio unit in claim 65, wherein the number of bits may vary, and wherein the electronic circuitry is configured to employ an error correction scheme adaptable to the variable number of bits used.

68. The radio unit in claim 59, wherein the data field is in the payload.

69. The radio unit in claim 59, wherein the data field is in the header.

70. The radio unit in claim 59, wherein the data field indicates a transport format for the data packet.

71. The radio unit in claim 70, wherein a transport channel includes a set of available transport format combinations, and wherein the electronic circuitry is configured to determine the error correction bits based on the set of available transport format combinations.

72. The radio unit in claim 71, wherein the electronic circuitry is configured to correct one or more errors in the header using the set of available transport format combinations.
